(19) United States
(12) Patent Application Publication
(10) Pub. No.: US 2012/0034586 A1
(43) Pub. Date: Feb. 9, 2012

(54) PULSE SIMULATOR AND A METHOD FOR SIMULATING PULSE

(76) Inventor: Oystein Gomo, Hundvag (NO)

(21) Appl. No.: 12/850,043

(22) Filed: Aug. 4, 2010

(51) Int. Cl. G09B 23/28

(52) U.S. Cl. 434/265

(57) ABSTRACT

The present invention relates to an improved pulse simulator and to an improved method for simulating pulse. It comprises a palpation conveyor connected with a flexible pump means. The flexible pump is operatively coupled to a solenoid arranged about a fixed core. The solenoid is magnetized and demagnetized by an electrical energy source causing back and forth motion of the solenoid, with consequential expansion and contraction of the flexible pump means, thereby releasing fluid in back and forth direction to the palpation conveyor for generating pulse sensation.

### TECHNICAL FIELD

The present invention in general, relates to an improved pulse simulator and to an improved method for simulating pulse. In particular, it relates to a device for simulating heart's pulse which has a simplified construction, requires less energy for its running and to a method for training medical students applying such device, which is user friendly, technically superior for creating real life pulse sensation and requires less energy. The present invention also ensures versatility in physical implementation.

Preferably, the device is adapted for implementation in a medical training manikin.

### BACKGROUND ART

With the increasing modernization in medical science, the need for sophisticated/accurate techniques and devices for training medical trainees has intensified. It is an established fact that feeling/sensing the heart's pulse is of immense importance in diagnosing the condition of the patient. A lack of or a weak pulse is a decisive factor to judge when and if cardiopulmonary resuscitation (CPR) has to be initiated or not. Moreover, the pulse rate and insensitivity can be a factor in diagnosing a patient's condition.

It is traditionally known that pulse is the number of heart beats per minute. The locations where pulse is usually measured are (a) back of the knees, (b) groin, (c) neck, (d) temple, (e) top or inner side of the foot and (f) wrist. In these areas, an artery passes closest to the skin, and it is easy to get the pulse from outside the body by touch.

As stated above, in recent years training medical trainees/students to accurately detect and measure pulse rates has been of prime importance in the field of medical sciences. Practical training on living animals/human beings by experienced medical experts continue to be a traditionally popular method of imparting medical training/education. However, the training of detecting and measuring pulse rates is achieved under the present scenario, to a great extent with the help of training manikins equipped with pulse simulating devices at one or more of the locations, as indicated in the preceding paragraph. The students in that event, feel the pulse by touching such locations of the manikin, which is of course monitored by the expert, to assess/supervise the degree of perfection achieved by the student.

Currently, two types of pulses are used in simulators:

1. Pneumatic pulses powered by an external compressor and controlled by a valve. It involves pulse-activation by depressing a foil-switch that lies under the flexible tubing that simulates the blood arteries.
2. Electromechanical pulses giving a direct, linear motion powered by a solenoid. It involves pulse-activation by depressing the pulse-body that senses the motion by impedance change in a second solenoid.

The general drawbacks which are encountered in the aforesaid two types are broadly as follows:

Pneumatic Pulses:
a. Uses a lot of air and is therefore not suitable for simulators with external compressor.
b. Generates disturbing clicking noise from internal valve.
c. Requires tubing running to each pulse site

Electromechanical Pulses:
a. Requires a lot of space. Much too large to fit in baby or child simulators. It is difficult to give a correct positioning for carotid pulses in adult simulators.
b. Sensitive to palpation direction.
c. Does not feel like an artery.
d. Jams easily.

Medical science, in recent years has witnessed several patents in the field of pulse simulating devices, which are intended for imparting perfect training/education to medical students/trainees for the purpose of solving the aforesaid drawbacks.

U.S. Pat. No. 7,510,398 discloses a simulation apparatus and teaching system, which includes a computer with input and output devices and a simulation apparatus. The simulation apparatus includes a housing, where the housing includes a tactile output subsystem for simulating pressure pulses corresponding to a pulse, an audio output subsystem for simulating heart sounds or other bodily sounds and a visual output subsystem for simulating visual attributes associated with a given condition. The output subsystem is under computer control and via interaction with a user. The computer instructs the output subsystem to generate the symptoms associated with a given condition in a temporally correlated or simultaneous manner so that a user is able to experience the visual, audio and tactile attributes associated with a given condition.

It is also known to have pulse devices having a hollow elastic bead or pillow, which is supplied with an alternating gas or liquid pressure from a pump. An example is shown in DE 3301111. The instructor may start and stop the pump and, thus, put the student to various tests. A pressure sensor is placed behind the pillow for transmitting signals when the student touches the pulse point and the instructor can record that the student is carrying out a correct diagnosis.

In all the pulse simulator devices, such as disclosed in U.S. Pat. No. 7,510,398 and DE 3301111, the need for a modern pulse simulator device, which works on a simple principle and simultaneously requires simple machinery and less energy for running, is not fully met. Further, overcoming all the drawbacks as stated hereinbefore in existing systems have not been taught by such devices. Further, U.S. Pat. No. 7,510,398 advocates involvement of a number of components, to ensure that perfection is not compromised. Known devices such as DE 3301111, have the same disadvantages. Further, such devices have the requirement of using a pump which not only consumes substantial energy which becomes a menace, particularly during battery operation, but also creates sound, prompting the student to feel the pulse, thus causing hindrance to his training by rendering the same unrealistic. WO 97/02553 (=U.S. Pat. No. 6,007,342) of Asmund S. Laerdal A S, the predecessor of the present assignee, somewhat gets rid of this problem by disclosing a device for simulated heart's pulse in manikins and apparatus in connection with training how to feel and recognize pulse. It has an armature, which is subjected to pulsating movements recognizable by touch. The armature coil surrounds the stator of a permanent magnet at starting point and is resiliently suspended in relation to the stator. The pulsating movement is caused by a pulse generator, which gets started and stopped depending upon the signal from a detector coil. It is the armature, which is subjected to pulsating movements, for simulating the pulse to be recognized and measured by the student. This device, of course substantially solves the need for requirement for high energy for operation. Further, the problem of generation of sound during its running and thereby rendering the training unrealistic is solved by this device.

However, the long felt need for designing a pulse simulator which takes care of the drawbacks in the existing system, which is student friendly due to simplified construction, facilitates accurate and realistic training, ensures versatility in physical implementation, involves requirement of less energy for operation and is adaptable to be monitored/varied by the instructor/expert in respect of frequency, amplitude and strength was not focused in its entirety. This was particularly, having regard to the fact that the devices known in prior art for simulating pulses, were not fully focused on making the item subjected to pulsating movements as light as possible.

Accordingly, there is a long felt need for providing a simplified pulse simulator, which by virtue of its simplified construction is user friendly and takes care of the drawbacks in the existing system, is perfect in imparting realistic training to students and in ensuring versatility in physical implementation, requires less energy in operation, involves minimum sound and of course, involves subjecting a very light object to pulsating movements by a simplified arrangement, for simulating pulse sensation to be recognized and measured by the student.

The present invention meets the aforesaid long felt need.

All through out the specification including the claims, the words “solenoid”, “pulse”, “bellows”, “pressure sensor”, “core”, “pulse actuator”, “palpation conveyor”, “palpation initiator”, “manikin”, are to be interpreted in the broadest sense of the respective terms and includes all similar items in the field known by other terms, as may be clear to persons skilled in the art. Restriction/limitation, if any, referred to in the specification, is solely by way of example and understanding the present invention.

### SUMMARY OF INVENTION

It is the principal object of the present invention to provide an improved device for simulating heart's pulse in a training apparatus such as a manikin, where pulse can be accurately recognized and measured by a student, for imparting a realistic medical training and which device ensures versatility in physical implementation and also substantially reduces/nullifies the known drawbacks of existing systems.

It is another object of the present invention to provide an improved device for simulating heat's pulse in a training apparatus such as a manikin, where pulse is simulated by subjecting a very light object to pulsating movements.

It is another object of the present invention to provide an improved device for simulating heart's pulse in a training apparatus, such as a manikin which involves a very simplified arrangement, thereby requiring substantially less energy for its operation.

It is a further object of the present invention to provide an improved technology for training medical students for recognizing and measuring heart's pulse such that the amplitude, frequency and strength of the pulse, simulated can be varied, for simulating real life situation.

It is yet another object of the present invention, to provide an improved device for simulating heart's pulse in a training apparatus such as a manikin which is adapted to prevent generation of pulse, if the student presses the manikin incorrectly, for recognizing pulse sensation.

It is a further object of the present invention to provide an improved method for simulating a heart's pulse in a training apparatus such as a manikin where pulse can be accurately recognized and measured by a student, for imparting a realistic medical training.

How the foregoing objects are achieved and the other aspects of the present invention will be clear from the following description, which is purely by way of understanding and not by way of any sort of limitation.

Accordingly the present invention provides a device for simulating heart's pulse in a training apparatus such as a training manikin, comprising at least one palpation conveyor connected with a flexible pump means, said flexible pump means being operatively coupled to a solenoid arranged about a fixed core, said solenoid being adapted to be magnetized and demagnetized by a suitable electrical energy source causing back and forth motion of said solenoid relative to said core, with consequential expansion and contraction of said flexible pump means, thereby releasing fluid in back and forth direction to said palpation conveyor for generating pulse sensation on said training apparatus, next to said palpation conveyor.

In accordance with preferred embodiments of the device of the present invention as described in the preceding paragraph:
said palpation conveyor comprises a soft thin-walled tube adapted to pass fluid there through for generating pulse sensation on said training apparatus, next to said soft thin-walled tube.

The present invention also provides a device for simulating heart's pulse in a training apparatus such as a manikin, comprising at least a palpation initiator coupled to a flexible pump means, said flexible pump means being operatively coupled to a solenoid arranged about a fixed core, said solenoid being adapted to be magnetized and demagnetized by a suitable electrical energy source, triggered by a pressure sensor means, in the event of which back and forth motion of said solenoid relative to said fixed core is initiated, causing expansion and contraction of said flexible pump means, whereby fluid is released in back and forth direction by said flexible pump means via said palpation initiator for generating pulse sensation on said training apparatus, next to said palpation initiator.

In accordance with preferred embodiments of the device of the present invention as described in the preceding paragraph:
said electrical energy source is a battery in connectivity with a break switch, said battery being adapted to be triggered by said pressure sensor only in the event of detection of a pressure increase in said device within a preset range.
said palpation initiator is a soft thin-walled tube having fluid therein and being adapted to displace the fluid in the event of touching the manikin next to said tube sufficiently to inflict a force against the outside of said thin-walled tube.
said flexible pump means comprises flexible bellows.
said solenoid and said core are linearly arranged within a housing, resting on a platform and operatively controlled by a printed circuit board; mounted on said platform.
said solenoid is adapted to generate a pulse frequency of pre-determined frequency and a pulse amplitude for a pre-determined duration by means of a suitably developed on board software.
said device is adapted to be recorded and/or displayed on a remotely connected display device for instantaneous assessment or for assessment at leisure.
said device is mounted within a housing with ventilation facility for prevention of attraction of foreign material by the magnetic field of the solenoid, when magnetized.

The present invention also provides a device for simulating heart's pulse in a training apparatus such as a manikin, comprising at least one soft thin-walled tube, coupled with flexible pump bellows, said bellows being operatively coupled to a solenoid arranged about a fixed core, said solenoid being adapted to be magnetized and demagnetized by a battery, in the event of which back and forth motion of said solenoid is caused relative to said core, such that expansion and contraction of said flexible bellows is caused, whereby fluid is released in back and forth direction to said thin-walled tube, for generating pulse sensation on said training apparatus, next to said thin-walled tube.

The present invention also provides a method for simulating a heart's pulse in a training apparatus such as a manikin comprising:
actuating at least one palpation initiator next to said manikin by applying touch pressure thereon and thereby displacing fluid out of said palpation initiator;
transmitting said fluid to a pump means coupled to said palpation initiator, said pump means being coupled to a solenoid;
causing said solenoid to move fractionally relative to a fixed core, thereby activating a position sensor assigned to said solenoid;
triggering an electrical energy source by said position sensor in the event of detection of displacement of said solenoid within a pre-set value range;
causing back and forth motion of said solenoid relative to said core by magnetization and demagnetization effect triggered by said electrical energy source;

thereby causing expansion and contraction of said pump means for releasing fluid in back and forth direction to said palpation initiator for generating pulse sensation on said training apparatus, next to said palpation initiator.

In accordance with preferred embodiments of the method described in the preceding paragraph:
said palpation initiator comprises at least one thin walled tube adapted to allow movement of fluid there through, said flexible pump means comprises flexible bellows, said electrical energy source being a battery in connectivity with a break switch.
at least one of the pulse frequency, pulse amplitude, pulse strength and duration of the pulse is computer controlled.

The present invention also provides a device for simulating heart's pulse in a training apparatus such as a manikin, comprising at least a palpation initiator coupled to a flexible pump means, said flexible pump means being operatively coupled to a solenoid arranged about a fixed core, said solenoid being assigned to a position sensor adapted to detect displacement of said solenoid from its starting position, said solenoid being adapted to be magnetized and demagnetized by a suitable electrical energy source triggered by said position sensor, in the event of which back and forth motion of said solenoid is caused relative to said fixed core, such that expansion and contraction of said flexible pump means is caused, whereby fluid is released in back and forth direction by said flexible pump means to said palpation initiator for generating pulse sensation on said training apparatus, next to said palpation initiator.

In accordance with preferred embodiments of the device of the present invention as described in the preceding paragraph:
said electrical energy source is a battery in connectivity with a break switch, said battery being adapted to be triggered by said position sensor only in the event of detection of displacement of said solenoid, within a pre-set value range.

The present invention also provides a method for simulating a heart's pulse in a training apparatus such as a manikin comprising:
actuating at least a palpation initiator next to said manikin by applying touch pressure thereon and displacing fluid along it; a pump means being coupled to said palpation initiator at its one end, said pump means being also coupled to a solenoid at its other end which is arranged about a fixed core;
transmitting said fluid to a pressure sensor;
activating an electrical energy source by said pressure sensor in the event of detection of pressure within a preset value range;
causing back and forth motion of said solenoid relative to said core by magnetization and demagnetization effect triggered by said electrical energy source;

thereby causing expansion and contraction of said pump means for releasing fluid in back and forth direction to said palpation initiator for generating pulse sensation on said training apparatus, next to said palpation initiator.

The present invention also provides a training apparatus such as a manikin for training medical students adapted to receive pulse sensation and to convey the same to a medical student in touch with an appropriate location on said training apparatus, said pulse sensation being generated by a device included in said training apparatus, said device comprising at least one palpation conveyor connected with a flexible pump means, said flexible pump means being operatively coupled to a solenoid arranged about a fixed core, said solenoid being adapted to be magnetized and demagnetized by a suitable electrical energy source causing back and forth motion of said solenoid relative to said core, with consequential expansion and contraction of said flexible pump means, thereby releasing fluid in back and forth direction to said palpation conveyor for generating pulse sensation on said training apparatus, next to said palpation conveyor.

The present invention also provides a training apparatus such as a manikin for training medical students adapted to receive pulse sensation and to convey the same to a medical student in touch with a appropriate location on said training apparatus, said pulse sensation being generated by a device included in said training apparatus, said device comprising at least a palpation initiator coupled to a flexible pump means, said flexible pump means being operatively coupled to a solenoid arranged about a fixed core, said solenoid being adapted to be magnetized and demagnetized by a suitable electrical energy source, triggered by a pressure sensor means, in the event of which back and forth motion of said solenoid relative to said fixed core is initiated, causing expansion and contraction of said flexible pump means, whereby fluid is released in back and forth direction by said flexible pump means via said palpation initiator for generating pulse sensation on said training apparatus, next to said palpation initiator.

The present invention further provides a training apparatus such as a manikin for training medical students adapted to receive pulse sensation and to convey the same to a medical student in touch with an appropriate location on said manikin, said pulse sensation being generated by a device included in said training apparatus, said device comprising at least a palpation initiator coupled to a flexible pump means, said flexible pump means being operatively coupled to a solenoid arranged about a fixed core, said solenoid being assigned to a position sensor adapted to detect displacement of said solenoid from its starting position, said solenoid being adapted to be magnetized and demagnetized by a suitable electrical energy source triggered by said position sensor, in the event of which back and forth motion of said solenoid is caused relative to said fixed core, such that expansion and contraction of said flexible pump means is caused, whereby fluid is released in back and forth direction by said flexible pump means to said palpation initiator for generating pulse sensation on said training apparatus, next to said palpation initiator.

### BRIEF DESCRIPTION OF DRAWINGS

The nature and scope of the present invention will be better understood from the accompanying drawings, which are by way of illustration of some preferred embodiments and not by way of any sort of limitation. In the accompanying drawings,

FIG. 1 illustrates a lay out of preferred embodiment of a device for simulating heart's pulse according to the present invention.

FIG. 2 illustrates a block diagram of the device illustrated in the FIG. 1, showing how the device works.

FIG. 3 illustrates a block diagram of the device illustrated in the FIG. 1, showing another method of working of the device.

FIG. 4 illustrates a block diagram of another preferred embodiment of the device for simulating heart's pulse according to the present invention.

### DETAILED DESCRIPTION OF THE INVENTION

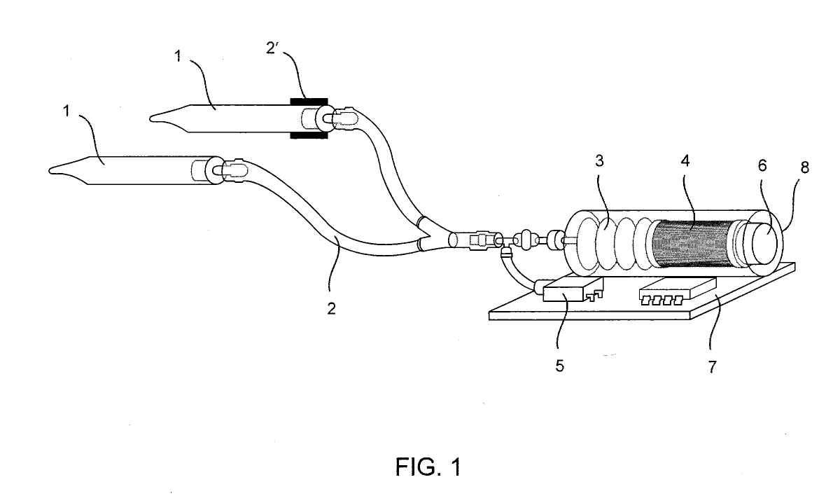

The accompanying FIG. 1 illustrates the lay-out of a preferred embodiment of the device for simulating heart's pulse according to the present invention. As can be seen, it basically comprises soft thin walled tubes 1 for pulse palpation connected with tubings 2 to flexible bellows 3. The tubes 2 are actually fluid lines, while the flexible bellows act as flexible pump means, as explained in the next paragraph. The flexible bellows are connected to a solenoid 4 that moves freely back and forth on a fixed magnetic core 6. The solenoid 4, flexible bellows 3 and fixed core 6, are preferably located within a housing 8 resting on a platform, having a printed circuit board (PCB) 7 mounted thereon. This is basically the complete system.

The tubing system is filled with a, preferably incompressible, fluid. When pulse palpation is performed, a small increased pressure in the fluid, due to the fact that a finger is pressed against one of the tubes 1, is detected by a pressure sensor 5. This prompts an electrical energy source such as a battery operable by a break switch (not shown) to magnetize and demagnetize the solenoid 4. This causes the solenoid 4 to slide freely back and forth on the fixed magnetic core 6.

It should be understood to persons skilled in the art, that the motion starts as the solenoid 4 gets magnetized and may be either pushing away from the core or pulling onto the core, whichever direction proves to give the highest efficiency. The solenoid 4, due to it's back and forth motion, pushes on the flexible bellows 3 that contains a fluid. An incompressible fluid (e.g. water or oil) is preferred, but air may be an option as well. The flexible bellows in that event undergo expansion and contraction and hence act as flexible pump means. It should be understood to persons skilled in the art, that the present invention covers all such flexible pump means and is not restricted to flexible bellows only. Pulse-beats in the fluid, generated by the solenoid/bellows, are felt in the soft thin-walled tubes 1 via the fluid line(s) 2 which may be tube(s), by way of example. The soft thin-walled tubes 1 are located under the skin of the manikin, so that the student/trainee is able to feel and measure the pulse by touching the appropriate location on the manikin skin.

As, it would be clear from the description in the aforesaid paragraph with reference to the accompanying FIG. 1, the device involves minimum number of components and has a very simplified construction. Further, the object which causes pulse to be simulated is a very light weight solenoid 4 which can be effectively activated by substantially low amount of electrical energy. Having regard to its light weight, very little energy is consumed by the device and the pulse modulation obtained is also better and more realistic, as will be explained subsequently.

The palpable silicon tubes 1 provide the sensation of natural arteries to the students. These can be placed at any pulse location without any size limitation. Furthermore, instead of moving the permanent magnet 6 back and forth to generate pulse sensation, in the device of the present invention, it is the light weight solenoid 4, which moves back and forth relative to the fixed metallic core 6.

The pulse-generator may be placed close to the tubes 1 but can also be placed in another location in the manikin, where there is more room than at the actual pulse-site. So, not only user friendliness, accuracy and energy saving are ensured, but also substantial versatility in physical implementation is achieved.

How the various advantages of the present invention are achieved is further explained hereinafter.

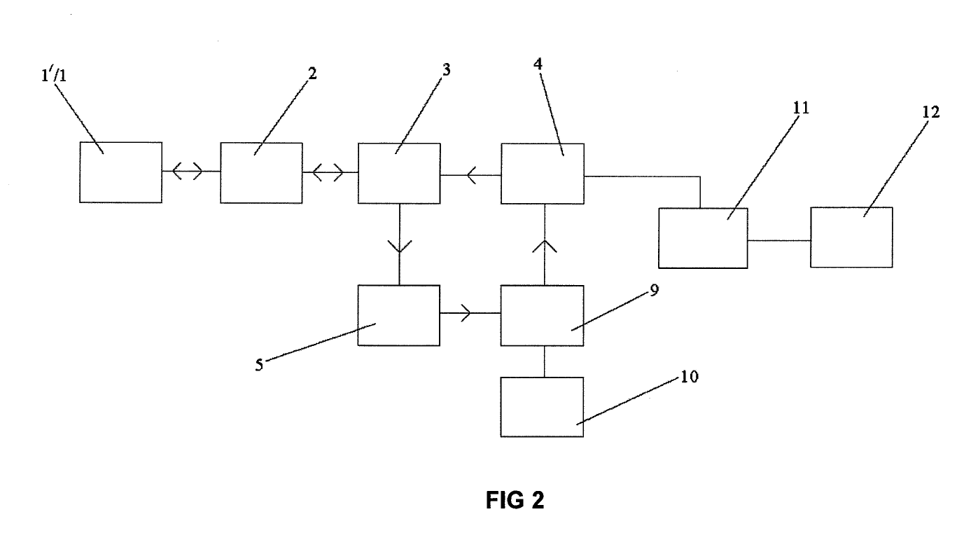

The accompanying FIG. 2, illustrates a block diagram of the device illustrated in the accompanying FIG. 1. The purpose of this block diagram is to understand a preferred method of working of the device. When the user put his/her finger against one of or both the soft thin-walled tubes 1, in contact with the manikin skin 1′ at an appropriate location, the fluid is displaced from the thin walled tube 1 to the tubings 2 and further to the pressure sensor 5. To ensure that no fluid passes in the direction of the bellows, there may be a first valve (not shown) which will remain closed in that direction and a second valve (not shown) will remain open, in the direction of the pressure sensor 5.

The arrangement is such that the two valves will not remain open simultaneously, during running of the device. The pressure in that event is detected by the pressure sensor 5. Preferably, the pressure is compared in a comparator for a pre-fixed value range. If the value range is satisfied, then a solenoid actuating circuit 9 is triggered by the pressure sensor 5, whereby an electrical energy source 10 magnetizes and demagnetizes the solenoid 4, by virtue of a break switch, to cause its back and forth direction motion relative to the core. Thereafter, the solenoid pushes on flexible bellows 3 that contains fluid as stated before. Fluid is pushed in back and forth mode through the tubings 2 to the soft thin-walled tubes 1. Thus, pulse-beats generated by the solenoid/bellows are felt in the flexible pulse palpation tubes 1, which are in contact with the manikin skin. The student/trainee is in that event able to feel and measure the pulse by touching the appropriate location on the manikin. As it will be understood by persons skilled in the art, if the trainee exerts excessive pressure while feeling the pulse or touches an incorrect location of the manikin, then no pulse will be generated.

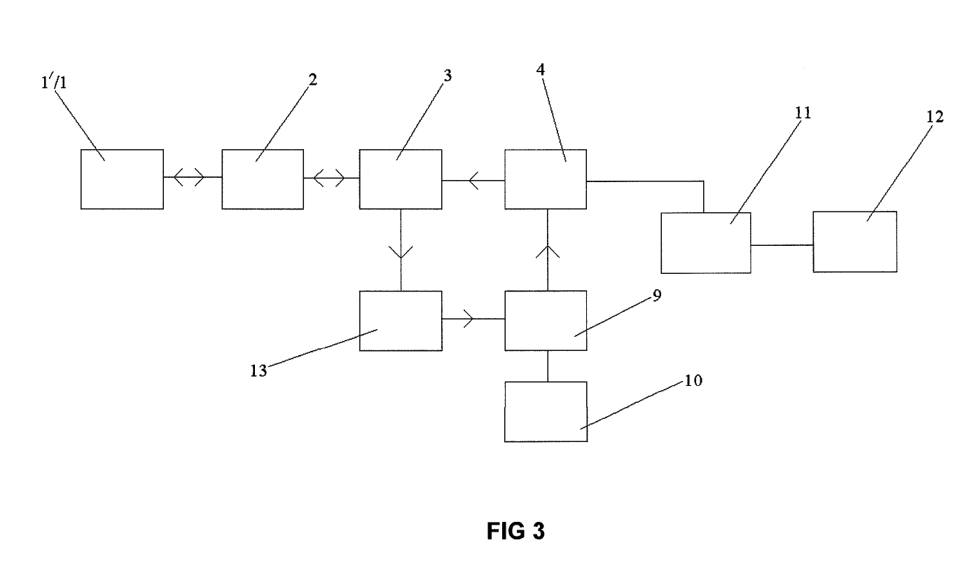

The accompanying FIG. 3 also illustrates a block diagram of the device illustrated in the accompanying FIG. 1. The purpose of this block diagram is to explain, by way of example, another preferred method of operation of the device. When the user puts his finger against the thin walled tube 1 in contact with the manikin skin 1′ at an appropriate location, the fluid will be displaced from the thin walled tube 1 to the tubings 2 and expand the bellows 3. In that event the first valve (not shown), as stated in the preceding paragraph, will remain open in the direction of solenoid and the second valve (not shown), as stated in the preceding paragraph, will remain closed to ensure that fluid is not transferred to the direction of the pressure sensor 5, shown in the accompanying FIG. 1. Alternatively, as a person skilled in the art will understand, the device may be devoid of any pressure sensor. This causes the solenoid 4 to move a fraction. A position sensor (not shown) in that event detects the movement of the solenoid from a starting position. If the displacement is within a pre-set range, then an electrical energy source 10 is triggered having a break switch so that the solenoid 4 is magnetized and demagnetized. The position sensor activates the electrical energy source by virtue of the solenoid displacement detection mechanism 13 and the solenoid actuating mechanism. The power supply 10, in collaboration with the solenoid actuating mechanism 9, magnetizes and demagnetizes the solenoid. Thereafter, the solenoid 4 pushes on the flexible bellows 3 that contain fluid as stated above. Fluid is pushed in back and forth mode through the tubings 2 to the soft thin-walled tubes 1. Thus, pulse-beats generated by the solenoid/bellows are felt in the flexible soft thin-walled tubes 1 with which the manikin skin is in contact. The student/trainee is able to feel and measure the pulse by touching the appropriate location on the manikin. As it will be understood by persons skilled in the art, if the trainee exerts excessive pressure while feeling the pulse or touches an incorrect location of the manikin, then no pulse will be generated as the position sensor will not trigger the solenoid actuating mechanism.

Preferably and not by way of any compulsive restriction, a foil switch 2′ may be used in connection with the thin walled tubes 1, for energizing the flexible bellows/solenoid.

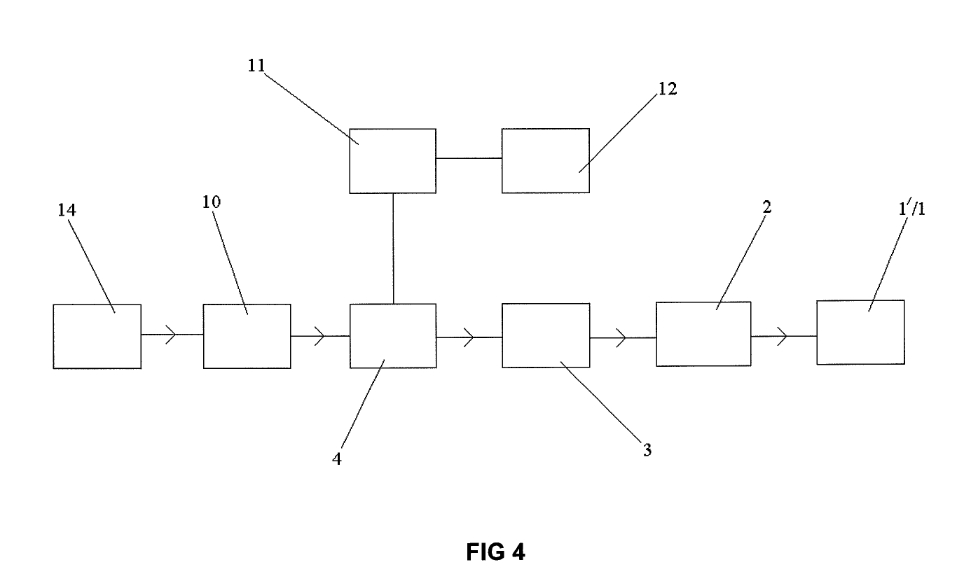

The accompanying FIG. 4 illustrates a block diagram of another preferred embodiment of the device, according to the present invention. Here the pulse generator is not internal; rather it is placed in another location, where there is more room than at the actual pulse site. In this case the solenoid is not actuated by the touch of the student. Rather, it is initiated by an independent switching device 14. The solenoid 4 is magnetized and demagnetized, and this causes the solenoid 4 to slide freely back and forth on the fixed magnetic core 6 (shown in FIG. 1). The solenoid 4, due to it's back and forth motion, pushes on the flexible bellows 3. Fluid is pushed in back and forth mode through the tubings 2 to the soft thin-walled tubes 1. Thus, pulse-beats generated by the solenoid/bellows are felt in the flexible soft thin walled tubes 1 with which the manikin skin 1′ is in contact. The student/trainee is able to feel and measure the pulse by touching the appropriate location on the manikin. It is noteworthy that according to this preferred embodiment, no pressure sensor is required, as the pulse generator is actuated at the first instance manually by operating a switch and not automatically by touching the tubes 1. It can be actuated by the teacher, through an independent switching device 14. So, the pulse sensation may be started or stopped by the teacher, depending upon his/her choice.

Further, it is an advantage if the teacher can detect from a remote location either at leisure or instantaneously, whether the student recognizes and measures the pulse correctly. To this end, the manikin may have a sensor operatively connected to a remote display unit 12, where each and every pulse generated is displayed with associated data, such as frequency, amplitude and strength, thereof. The display 12 is operatively connected to the pulse actuating solenoid 4 by means of an appropriate electrical circuit 11. In addition to a display there may also be a storage device.

It will be understood by persons skilled in the art that to create a real life situation, the pulse actuator is adapted to generate a pulse frequency/beat stroke of pre-determined frequency, amplitude and strength for a pre-determined duration, by means of a suitably connected on-board software. Preferably, the pulse actuator is a solenoid motor as explained above, which is operated by applying very low electrical energy such as a battery. By way of precaution the solenoid may be encased within a casing to eliminate any sound, which would prompt a student, causing hindrance to his training by rendering the same unrealistic. More preferably, the device is mounted within a housing with ventilation facility (not shown) for prevention of attraction of foreign material by the magnetic field of the solenoid, when magnetized.

The improved method of simulating heart's pulse according to the present invention preferably comprises actuating at least a palpation initiator in touch with said manikin by applying touch pressure thereon and displacing fluid along it. This causes transmission of said fluid along a flexible pump means connected to said palpation initiator, said flexible means being connected to a solenoid. Thereafter, said solenoid is moved fractionally relative to a fixed core around which said solenoid is placed, thereby activating a position sensor assigned to said solenoid. This causes a triggering of an electrical energy source by said position sensor, only in the event of detection of displacement of said solenoid 4 within a pre-set value range. Thus, back and forth motion of said solenoid 4 relative to said core takes place, by magnetization and demagnetization effect triggered by said electrical energy source. Thereby, expansion and contraction of the flexible pump means is caused for releasing fluid in back and forth direction via said palpation initiator for generating pulse sensation on said manikin, next to said palpation initiator.

As stated before, the method may also include activating a pressure sensor instead of a position sensor, at the first instance. Rest of the method is same as in the preceding paragraph. Further, the pulse actuator. i.e. the solenoid may be actuated by an independent switching device by the teacher, instead of by applying touch pressure. This has been elaborately illustrated and described with reference to the accompanying FIG. 4. In any event, if the pressure sensor has to be activated, then the solenoid can not be allowed to move a fraction from its starting position to activate the position sensor assigned to it.

From the elaborate preceding description it would be clear that the present invention achieves the following non-limiting advantages:

Imparts an accurate and a realistic medical training and ensures versatility in physical implementation.

Pulse is simulated by subjecting a very light object to pulsating movements, thus requiring substantially less electrical energy for its operation. Quicker movements can be achieved due to lighter weight of the solenoid.

The palpable silicon tubes give the realistic feeling like natural arteries, this and the simple construction and minimum number of components, make the device user friendly to both the teacher and the student. The palpable silicon tube can be placed at any pulse location without any size limitation.

Amplitude, frequency and strength of the pulse simulated can be varied, for simulating various real life situations.

The pulse generator is preferably internal of the manikin but can be placed at any location where there is more room than the actual pulse-site.

The device does not require too much space and only small volume of fluid is required.

No disturbing and misleading noise is generated for simulating pulse sensation.

The present invention has been described with reference to some drawings and preferred embodiments, purely for the sake of understanding and not by way of any limitation and the present invention includes all legitimate developments within the scope of what has been described hereinbefore and claimed in the appended claims.

1. A device for simulating heart's pulse in a training apparatus such as a training manikin, comprising at least one palpation conveyor connected with a flexible pump means, said flexible pump means being operatively coupled to a solenoid arranged about a fixed core, said solenoid being adapted to be magnetized and demagnetized by a suitable electrical energy source causing back and forth motion of said solenoid relative to said core, with consequential expansion and contraction of said flexible pump means, thereby releasing fluid in back and forth direction to said palpation conveyor for generating pulse sensation on said training apparatus, next to said palpation conveyor.

2. The device of claim 1 wherein said palpation conveyor comprises a soft thin-walled tube adapted to pass fluid there through for generating pulse sensation on said training apparatus, next to said soft thin-walled tube.

3. A device for simulating heart's pulse in a training apparatus such as a manikin, comprising at least a palpation initiator coupled to a flexible pump means, said flexible pump means being operatively coupled to a solenoid arranged about a fixed core, said solenoid being adapted to be magnetized and demagnetized by a suitable electrical energy source, triggered by a pressure sensor means, in the event of which back and forth motion of said solenoid relative to said fixed core is initiated, causing expansion and contraction of said flexible pump means, whereby fluid is released in back and forth direction by said flexible pump means via said palpation initiator for generating pulse sensation on said training apparatus, next to said palpation initiator.

4. The device of claim 3 wherein said electrical energy source is a battery in connectivity with a break switch, said battery being adapted to be triggered by said pressure sensor only in the event of detection of a pressure increase in said device within a preset range.

5. The device of claim 3 wherein said palpation initiator is a soft thin-walled tube having fluid therein and being adapted to displace the fluid in the event of touching the manikin next to said tube sufficiently to inflict a force against the outside of said thin-walled tube.

6. The device of claim 3 wherein said flexible pump means comprises flexible bellows.

7. The device of claim 3 wherein said flexible pump means, said solenoid and said core are linearly arranged within a housing, resting on a platform and operatively controlled by a printed circuit board; mounted on said platform.

8. The device of claim 3 wherein said solenoid is adapted to generate a pulse frequency of pre-determined frequency and a pulse amplitude for a pre-determined duration by means of a suitably developed on board software.

9. The device of claim 3 wherein pulse generated by said device is adapted to be recorded and/or displayed on a remotely connected display device for instantaneous assessment or for assessment at leisure.

10. The device of claim 3 wherein said device is mounted within a housing with ventilation facility for prevention of attraction of foreign material by the magnetic field of the solenoid, when magnetized.

11. A device for simulating heart's pulse in a training apparatus such as a manikin, comprising at least one soft thin-walled tube, coupled with flexible pump bellows, said bellows being operatively coupled to a solenoid arranged about a fixed core, said solenoid being adapted to be magnetized and demagnetized by a battery, in the event of which back and forth motion of said solenoid is caused relative to said core, such that expansion and contraction of said flexible bellows is caused, whereby fluid is released in back and forth direction to said thin-walled tube, for generating pulse sensation on said training apparatus, next to said thin-walled tube.

12. The device of claim 11 wherein at least two said soft thin walled tubes are coupled to said bellows.

13. A method for simulating a heart's pulse in a training apparatus such as a manikin comprising:
actuating at least one palpation initiator next to said manikin by applying touch pressure thereon and thereby displacing fluid out of said palpation initiator;
transmitting said fluid to a pump means coupled to said palpation initiator, said pump means being coupled to a solenoid;
causing said solenoid to move fractionally relative to a fixed core, thereby activating a position sensor assigned to said solenoid;
triggering an electrical energy source by said position sensor in the event of detection of displacement of said solenoid within a pre-set value range;
causing back and forth motion of said solenoid relative to said core by magnetization and demagnetization effect triggered by said electrical energy source;
thereby causing expansion and contraction of said pump means for releasing fluid in back and forth direction to said palpation initiator for generating pulse sensation on said training apparatus, next to said palpation initiator.

14. The method of claim 13 wherein said palpation initiator comprises at least one thin walled tube adapted to allow movement of fluid there through, said flexible pump means comprises flexible bellows, said electrical energy source being a battery in connectivity with a break switch.

15. The method of claim 13 wherein at least one of the pulse frequency, pulse amplitude, pulse strength and duration of the pulse is computer controlled.

16. A device for simulating heart's pulse in a training apparatus such as a manikin, comprising at least a palpation initiator coupled to a flexible pump means, said flexible pump means being operatively coupled to a solenoid arranged about a fixed core, said solenoid being assigned to a position sensor adapted to detect displacement of said solenoid from its starting position, said solenoid being adapted to be magnetized and demagnetized by a suitable electrical energy source triggered by said position sensor, in the event of which back and forth motion of said solenoid is caused relative to said fixed core, such that expansion and contraction of said flexible pump means is caused, whereby fluid is released in back and forth direction by said flexible pump means to said palpation initiator for generating pulse sensation on said training apparatus, next to said palpation initiator.

17. The device of claim 16 wherein said electrical energy source is a battery in connectivity with a break switch, said battery being adapted to be triggered by said position sensor only in the event of detection of displacement of said solenoid, within a pre-set value range.

18. A method for simulating a heart's pulse in a training apparatus such as a manikin comprising:
actuating at least a palpation initiator next to said manikin by applying touch pressure thereon and displacing fluid along it; a pump means being coupled to said palpation initiator at its one end, said pump means being also coupled to a solenoid at its other end which is arranged about a fixed core;
transmitting said fluid to a pressure sensor;
activating an electrical energy source by said pressure sensor in the event of detection of pressure within a preset value range;
causing back and forth motion of said solenoid relative to said core by magnetization and demagnetization effect triggered by said electrical energy source;
thereby causing expansion and contraction of said pump means for releasing fluid in back and forth direction to said palpation initiator for generating pulse sensation on said training apparatus, next to said palpation initiator.

19. A training apparatus such as a manikin for training medical students adapted to receive pulse sensation and to convey the same to a medical student in touch with an appropriate location on said training apparatus, said pulse sensation being generated by a device included in said training apparatus, said device comprising at least one palpation conveyor connected with a flexible pump means, said flexible pump means being operatively coupled to a solenoid arranged about a fixed core, said solenoid being adapted to be magnetized and demagnetized by a suitable electrical energy source causing back and forth motion of said solenoid relative to said core, with consequential expansion and contraction of said flexible pump means, thereby releasing fluid in back and forth direction to said palpation conveyor for generating pulse sensation on said training apparatus, next to said palpation conveyor.

20. A training apparatus such as a manikin for training medical students adapted to receive pulse sensation and to convey the same to a medical student in touch with a appropriate location on said training apparatus, said pulse sensation being generated by a device included in said training apparatus, said device comprising at least a palpation initiator coupled to a flexible pump means, said flexible pump means being operatively coupled to a solenoid arranged about a fixed core, said solenoid being adapted to be magnetized and demagnetized by a suitable electrical energy source, triggered by a pressure sensor means, in the event of which back and forth motion of said solenoid relative to said fixed core is initiated, causing expansion and contraction of said flexible pump means, whereby fluid is released in back and forth direction by said flexible pump means via said palpation initiator for generating pulse sensation on said training apparatus, next to said palpation initiator.

21. A training apparatus such as a manikin for training medical students adapted to receive pulse sensation and to convey the same to a medical student in touch with an appropriate location on said manikin, said pulse sensation being generated by a device included in said training apparatus, said device comprising at least a palpation initiator coupled to a flexible pump means, said flexible pump means being operatively coupled to a solenoid arranged about a fixed core, said solenoid being assigned to a position sensor adapted to detect displacement of said solenoid from its starting position, said solenoid being adapted to be magnetized and demagnetized by a suitable electrical energy source triggered by said position sensor, in the event of which back and forth motion of said solenoid is caused relative to said fixed core, such that expansion and contraction of said flexible pump means is caused, whereby fluid is released in back and forth direction by said flexible pump means to said palpation initiator for generating pulse sensation on said training apparatus, next to said palpation initiator.
